(19) United States
(12) Patent Application Publication
(10) Pub. No.: US 2012/0163212 A1
(43) Pub. Date: Jun. 28, 2012

(54) APPARATUS AND METHOD FOR DETECTING ABNORMAL TRAFFIC

(75) Inventors: Wang-Bong LEE, Daejeon-si (KR); Joon-Kyung Lee, Daejeon-si (KR)

(73) Assignee: Electronics and Telecommunications Research Institute, Daejeon (KR)

(21) Appl. No.: 13/332,972

(22) Filed: Dec. 21, 2011

(30) Foreign Application Priority Data
Dec. 22, 2010 (JP) 10-2010-0132731

(51) Int. Cl. H04L 12/26

(52) U.S. Cl. 370/252

(57) ABSTRACT

An apparatus and method for detecting abnormal traffic are provided. According to the apparatus and method, it is possible to easily detect abnormal traffic by analyzing a traffic image that is generated based on traffic statistics data provided by an external traffic analysis device or an internal traffic analysis device without the need to access a traffic analysis device that is hard to access or manipulate.

### CROSS-REFERENCE TO RELATED APPLICATION(S)

This application claims the benefit under 35 U.S.C. §119(a) of Korean Patent Application No. 10-2010-0132731, filed on Dec. 22, 2010, in the Korean Intellectual Property Office, the entire disclosure of which is incorporated herein by reference for all purposes.

### BACKGROUND

1. Field

The following description relates to a traffic monitoring technique, and more particularly, to an apparatus and method for detecting abnormal traffic.

2. Description of the Related Art

Detecting traffic packets that are transmitted via a network may generally be performed by a traffic analysis system. The traffic analysis system may analyze traffic, and may determine whether the traffic is abnormal based on the results of the analysis.

For example, in response to an amount of packets that are transmitted during a particular time zone exceeding a predetermined threshold, the traffic analysis system may determine that there is abnormal traffic. As another example, the traffic analysis system may detect abnormal traffic according to a predetermined policy. In this example, the traffic analysis system may use a particular analysis method and policy to detect abnormal traffic.

In a case in which there are multiple traffic measurement points, the complexity of the management and setting of an abnormal traffic policy may vary depending on the type of traffic analysis system. In addition, since each traffic analysis system uses a unique policy, the cost of the management and setting of an abnormal traffic policy may increase.

### SUMMARY

The following description relates to an apparatus and method for detecting abnormal traffic, in which abnormal traffic can be easily detected without the need to access a traffic access device that is relatively hard to access and manipulate.

In one general aspect, there is provided an apparatus for detecting abnormal traffic, the apparatus including: a traffic image processing unit configured to process a traffic image; a comparison image processing unit configured to generate a comparison image for detecting abnormal traffic and store the comparison image; and an image comparison unit configured to determine whether there is abnormal traffic by comparing the traffic image and the comparison image.

Other features and aspects may be apparent from the following detailed description, the drawings, and the claims.

### BRIEF DESCRIPTION OF THE DRAWINGS

FIG. 1 is a diagram illustrating an example of a network to which an apparatus for detecting abnormal traffic is applied.

FIG. 2 is a diagram illustrating an example of an apparatus for detecting abnormal traffic.

FIG. 3 is a flowchart illustrating an example of a method of detecting abnormal traffic.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

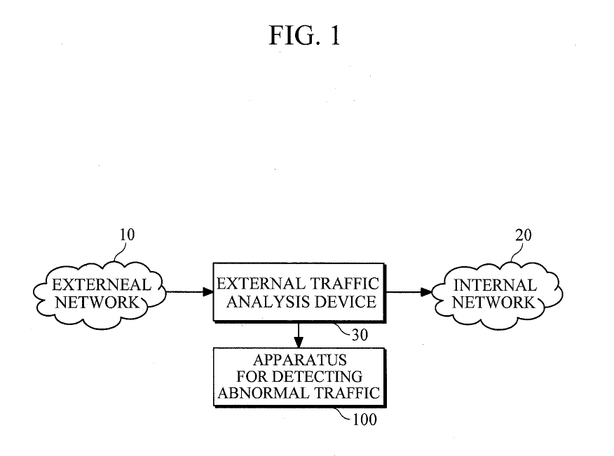

FIG. 1 illustrates an example of a network to which an apparatus for detecting abnormal traffic is applied. Referring to FIG. 1, an external traffic analysis device 30 such as a router device, a switch device or a firewall device that processes packets may be connected between an external network 10, for example, the internet, and an internal network 20, for example, a local network, and apparatus 100 for detecting abnormal traffic may be connected to the external traffic analysis device 30.

The external traffic analysis device 30 may have various functions such as analyzing traffic, determining network conditions, and the like. The apparatus 100 may detect abnormal traffic based on traffic statistics data or a traffic image provided by the external traffic analysis device 30.

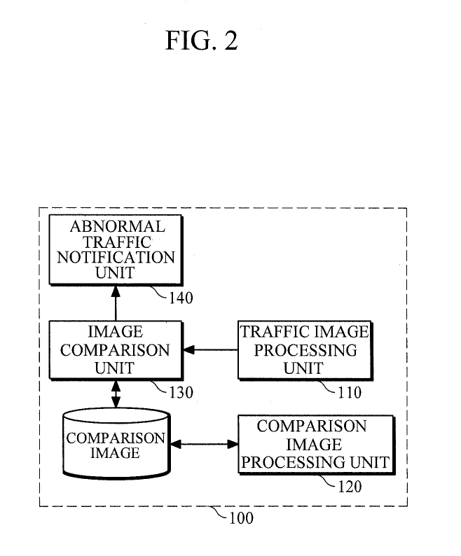

FIG. 2 illustrates an example of an apparatus for detecting abnormal traffic. Referring to FIG. 2, apparatus 100 includes a traffic image processing unit 110, a comparison image processing unit 120, and an image comparison unit 130.

The traffic image processing unit 110 may process a traffic image. For example, the traffic image may be an image that visualizes the traffic pattern of packets currently being transmitted.

For example, the traffic image processing unit 110 may be configured to receive traffic statistics data from an external traffic analysis device (not shown) or an internal traffic analysis device (not shown) and generate a real-time traffic image based on the received traffic statistics data.

As another example, the traffic image processing unit 110 may be configured to receive a real-time traffic image from the external traffic analysis device or the internal traffic analysis device. In this example, the external traffic analysis device or the internal traffic analysis device may generate the real-time traffic image based on traffic statistics data, and may transmit the real-time traffic image to the apparatus 100.

For example, the external traffic analysis device may be a router device, a switch device, or a firewall device. In this example, the traffic image processing unit 110 may be configured to receive traffic statistics data or a traffic image from the external traffic analysis device via a Simple Network Management Protocol (SNMP) interface, a Remote Network Monitoring (RMON) interface, or a NetFlow interface.

For example, the internal traffic analysis device may be a packet capture board. In this example, the traffic image processing unit 110 may be configured to receive traffic statistics data or a traffic image from the internal traffic analysis device via a universal peripheral component interconnect (PCI) interface.

The comparison image processing unit 120 may generate a comparison image for detecting abnormal traffic, and may store the comparison image. For example, the comparison image processing unit 120 may be configured to generate a comparison image with a predetermined traffic pattern.

The comparison image processing unit 120 may also be configured to modify the traffic pattern of the comparison image. Accordingly, it is possible to actively respond to any packet variations by properly modifying the traffic pattern of the comparison image.

The comparison image processing unit 120 may be configured to store a comparison image with a compressed traffic pattern. For example, the comparison image processing unit 120 may compress a traffic pattern using a Hidden Markov Model (HMM) method. Accordingly, it is possible to increase the speed of searching for a comparison image.

The image comparison unit 130 may determine whether there is abnormal traffic by comparing a traffic image provided by the traffic image processing unit 110 and a comparison image stored in the comparison image processing unit 120.

For example, the image comparison unit 130 may compare a traffic image that visualizes the traffic pattern of packets currently being transmitted and a comparison image with a predetermined traffic pattern, and may determine that there is abnormal traffic in response to the traffic image and the comparison image being identical. In this example, it is possible to detect malicious codes such as a worm virus, a backdoor program or the like.

The apparatus 100 may easily detect abnormal traffic by analyzing a traffic image that is generated based on traffic statistics data provided by the external traffic analysis device or the internal traffic analysis device without the need to access a traffic analysis device that is hard to access or manipulate.

The apparatus 100 may also include an abnormal traffic notification unit 140. In response to the results of comparison of a traffic image and a comparison image indicating that there is abnormal traffic, the abnormal traffic notification unit 140 may report the detection of abnormal traffic.

For example, the abnormal traffic notification unit 140 may alert a manager by displaying an abnormal traffic warning message on a screen. As another example, the abnormal traffic notification unit 140 may transmit the abnormal traffic warning message to the manager's mobile phone or output an abnormal traffic warning sound to alert the manager.

The abnormal traffic notification unit 140 may be configured to create and store a log for abnormal traffic. The log may be used later for various purposes such as analyzing a network environment.

The traffic image processing unit 110 may be configured to display a traffic image using a Graphic User Interface (GUI).

Accordingly, the manager may be notified of the detection of abnormal traffic by the abnormal traffic notification unit 140, and may identify the abnormal traffic from a traffic image that is displayed by the GUI.

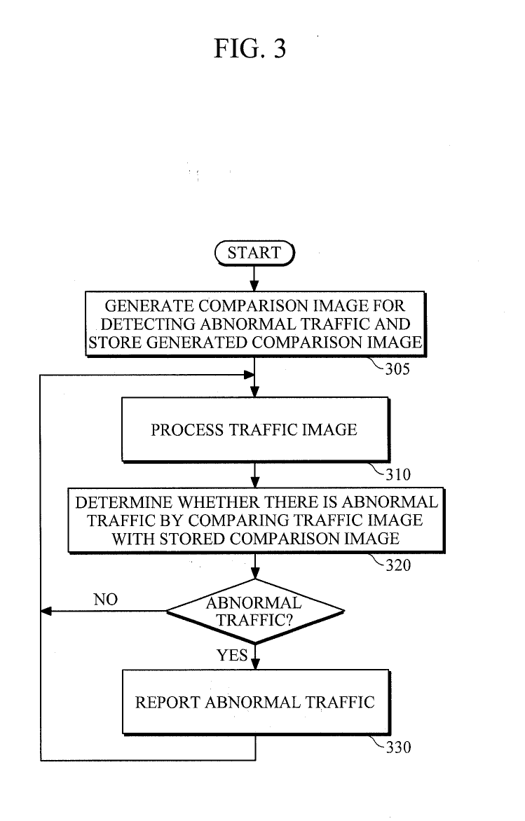

An example of the operation of the apparatus 100, i.e., an example of detecting abnormal traffic is further described with reference to FIG. 3. FIG. 3 illustrates an example of a method of detecting abnormal traffic.

Referring to FIG. 3, in 310, an apparatus for detecting abnormal traffic may process a traffic image. For example, the traffic image may be an image that visualizes the traffic pattern of packets currently being transmitted.

For example, in 310, the apparatus may receive traffic statistics data from an external traffic analysis device or an internal traffic analysis device, and may generate a real-time traffic image based on the received traffic statistics data.

As another example, in 310, the apparatus may be configured to receive a real-time traffic image from the external traffic analysis device or the internal traffic analysis device. In this example, the external traffic analysis device or the internal traffic analysis device may generate the real-time traffic image based on traffic statistics data, and may transmit the real-time traffic image to the apparatus.

In 320, the apparatus may determine whether there is abnormal traffic by comparing the traffic image and a previously-stored comparison image.

For example, in 320, the apparatus may compare the traffic image, which visualizes the traffic pattern of the packets currently being transmitted, and a comparison image with a predetermined traffic pattern, and may determine that there is abnormal traffic in response to the traffic image and the comparison image being identical. In this example, it is possible to detect malicious codes such as a worm virus, a backdoor program or the like.

In 330, in response to it being determined in 320 that there is abnormal traffic, the apparatus may report the detection of abnormal traffic. For example, the apparatus may be configured to create and store a log for abnormal traffic.

The apparatus may easily detect abnormal traffic by analyzing a traffic image that is generated based on traffic statistics data provided by the external traffic analysis device or the internal traffic analysis device without the need to access a traffic analysis device that is hard to access or manipulate.

For example, the apparatus may generate a comparison image for detecting abnormal traffic, and may store the comparison image. In this example, the apparatus may detect abnormal traffic by comparing the traffic image with the comparison image.

The apparatus may be configured to display the traffic image to a manager via a GUI. Accordingly, the manager may be notified of the detection of abnormal traffic in 330, and may identify the abnormal traffic from a traffic image that is displayed by the GUI.

As described above, it is possible to easily detect abnormal traffic by analyzing a traffic image that is generated based on traffic statistics data provided by an external traffic analysis device or an internal traffic analysis device without the need to access a traffic analysis device that is hard to access or manipulate.

In addition, since abnormal traffic can be easily detected simply by connecting an apparatus for detecting abnormal traffic to an existing traffic analysis device, it is possible to reduce the cost of detecting abnormal traffic.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for detecting abnormal traffic, the apparatus comprising:
a traffic image processing unit configured to process a traffic image;
a comparison image processing unit configured to generate a comparison image for detecting abnormal traffic and store the comparison image; and
an image comparison unit configured to determine whether there is abnormal traffic by comparing the traffic image and the comparison image.

2. The apparatus of claim 1, wherein the traffic image processing unit is further configured to receive traffic statistics data from an external traffic analysis device or an internal traffic analysis device and generate a real-time traffic image based on the received traffic statistics data.

3. The apparatus of claim 1, wherein the traffic image processing unit is further configured to receive a real-time traffic image from an external traffic analysis device or an internal traffic analysis device.

4. The apparatus of claim 1, further comprising:
an abnormal traffic notification unit configured to, in response to results of comparison performed by the image comparison unit indicating that there is abnormal traffic, report detection of the abnormal traffic.

5. The apparatus of claim 1, wherein the traffic image processing unit is further configured to display the traffic image via a Graphic User Interface (GUI).

6. The apparatus of claim 1, wherein the comparison image processing unit is further configured to generate a comparison image with a predetermined traffic pattern.

7. The apparatus of claim 6, wherein the comparison image processing unit is further configured to modify the traffic pattern of the comparison image.

8. The apparatus of claim 6, wherein the comparison image processing unit is further configured to store a comparison image with a compressed traffic pattern that is obtained by compressing the predetermined traffic pattern.

9. The apparatus of claim 8, wherein the comparison image processing unit is further configured to compress the predetermined traffic pattern using a Hidden Markov Model (HMM) method.

10. The apparatus of claim 4, wherein the abnormal traffic notification unit is further configured to create and store a log for the abnormal traffic.

11. The apparatus of claim 2, wherein the external traffic analysis device comprises one of a router device, a switch device, and a firewall device.

12. The apparatus of claim 11, wherein the traffic image processing unit is further configured to receive the traffic statistics data from the external traffic analysis device via a Simple Network Management Protocol (SNMP) interface, a Remote Network Monitoring (RMON) interface, or a NetFlow interface.

13. The apparatus of claim 2, wherein the internal traffic analysis device comprises a packet capture board.

14. The apparatus of claim 12, wherein the traffic image processing unit is further configured to receive the traffic statistics data from the internal traffic analysis device via a universal peripheral component interconnect (PCI) interface.

15. A method of detecting abnormal traffic, the method comprising:
processing a traffic image;
determining whether there is abnormal traffic by comparing the traffic image and a previously-stored comparison image; and
in response to results of the comparing indicating that there is abnormal traffic, reporting detection of the abnormal traffic.

16. The method of claim 15, wherein the processing comprises receiving traffic statistics data from an external traffic analysis device or an internal traffic analysis device and generating a real-time traffic image based on the received traffic statistics data.

17. The method of claim 15, wherein the processing comprises receiving a real-time traffic image from an external traffic analysis device or an internal traffic analysis device.

18. The method of claim 15, further comprising:
generating a comparison image for detecting abnormal traffic and storing the generated comparison image.

19. The method of claim 15, wherein the processing comprises displaying the traffic image via a GUI.

20. The method of claim 15, wherein the reporting comprises creating and storing a log for the abnormal traffic.
